(19) United States
(12) Patent Application Publication
(10) Pub. No.: US 2020/0150574 A1
(43) Pub. Date: May 14, 2020

(54) IMAGE FORMING APPARATUS

(71) Applicant: CANON KABUSHIKI KAISHA, Tokyo (JP)

(72) Inventor: Katsuya Nose, Kashiwa-shi (JP)

(21) Appl. No.: 16/674,307

(22) Filed: Nov. 5, 2019

(30) Foreign Application Priority Data
Nov. 12, 2018 (JP) 2018-212579

(51) Int. Cl. G03G 15/00; G03G 15/08

(52) U.S. Cl. CPC G03G 15/5025; G03G 15/0886; G03G 15/5037; G03G 15/5041

(57) ABSTRACT

An image forming apparatus includes an image bearing member, a developing apparatus, a developer accommodating container, a density detecting portion, and, an execution unit. The density detecting portion configured to output an output voltage corresponding to a toner density in the developer container if a control voltage is applied to the density detecting portion. The execution unit configured to execute a mode if an initial setting of the density detecting portion is performed in the state where the developer accommodating container is attached to the image forming apparatus at an attachment position in an initial installation of the image forming apparatus. In the mode, the execution unit sets a preset control voltage as the control voltage to be applied to the density detecting portion when an image is formed.

### BACKGROUND OF THE INVENTION

### Field of the Invention

The present invention relates to image forming apparatuses such as copying machines, printers, facsimiles, and multifunction printers having a plurality of functions of these products.

### Description of the Related Art

A known developing apparatus of an image forming apparatus includes a density detecting portion, such as an inductance sensor, that detects the toner density of the developer contained in a developer container of the developing apparatus. The inductance sensor, when applied with a control voltage, outputs an output voltage corresponding to a toner density of the toner of the developer container. The output voltage from the inductance sensor may vary for an identical toner density, because of the individual difference of the inductance sensor, the dispersion in assembling the inductance sensor to the developer container, and the like. For this reason, Japanese Patent Application Publication No. 2000-56639 proposes a configuration in which the initial setting of the inductance sensor is performed in the installation of the image forming apparatus.

By the way, one configuration to supply the developer from a toner container, which is a developer accommodating container, to the developer container of the developing apparatus has no hopper used to temporarily store the developer from the toner container and supply the developer to the developer container. In such a configuration without the hopper, when the toner container is attached to an apparatus body of the image forming apparatus at a predetermined position serving as attachment position of the apparatus body, an outlet of the toner container and an inlet of the developer container communicate with each other. In this case, if the initial setting of the inductance sensor is performed in a state where the toner container is attached to the apparatus body at the predetermined position of the apparatus body, the developer may enter the developer container, before the initial setting, from the toner container, possibly making the toner density of the developer container different from a factory default value. Thus, if the toner density is different from the factory default value, the initial setting of the inductance sensor cannot be accurately performed.

### SUMMARY OF THE INVENTION

According to one aspect to the invention, an image forming apparatus includes an image bearing member, a developing apparatus includes a developer container in which developer, containing toner and carrier, is accommodated and configured to develop an electrostatic latent image formed on the image bearing member by using the developer in the developer container, the developer container includes an inlet through which the developer container receives the developer, a developer accommodating container in which developer is accommodated, and which includes an outlet through which the developer in the developer accommodating container is discharged, the developer accommodating container being configured to attach to the image forming apparatus at an attachment position, the outlet of the developer accommodating container communicating with the inlet of the developer container in a state where the developer accommodating container is attached to the image forming apparatus at the attachment position so that the developer in the developer accommodating container flows from the outlet to the developer container, a density detecting portion configured to output an output voltage corresponding to a toner density in the developer container if a control voltage is applied to the density detecting portion, and, an execution unit configured to execute a first mode if an initial setting of the density detecting portion is performed in a state where the developer accommodating container is not attached to the image forming apparatus at the attachment position in an initial installation of the image forming apparatus, and to execute a second mode if the initial setting of the density detecting portion is performed in the state where the developer accommodating container is attached to the image forming apparatus at the attachment position in the initial installation of the image forming apparatus, wherein, in the first mode, the execution unit applies a plurality of control voltages to the density detecting portion, determines a first control voltage based on the plurality of control voltages and a plurality of output voltages outputted from the density detecting portion when the plurality of control voltages are applied to the density detecting portion, and sets the first control voltage as the control voltage to be applied to the density detecting portion when an image is formed, and wherein, in the second mode, the execution unit sets a preset second control voltage as the control voltage to be applied to the density detecting portion when an image is formed.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus of a first embodiment.

FIG. 2 is a schematic configuration diagram of an image processing unit of the first embodiment.

FIG. 3 is a block diagram illustrating a system configuration of the image forming apparatus of the first embodiment.

FIG. 4 is a cross-sectional view schematically illustrating a developing apparatus and a toner supply configuration of the first embodiment.

FIG. 5 is a longitudinal-sectional view schematically illustrating the developing apparatus of the first embodiment.

FIG. 6 is a sectional view of a toner container of the first embodiment, in a state where the volume of a pump portion of the toner container is increased.

FIG. 7 is a sectional view of the toner container of the first embodiment, in a state where the volume of the pump portion of the toner container is decreased.

FIG. 8 is a diagram for illustrating a mechanism to allow the pump portion of the first embodiment to move.

FIG. 9A is a table of target TD ratios of the first embodiment, each defined for the corresponding number of image-formed sheets.

FIG. 9B is a graph of the target TD ratios of the first embodiment, each defined for the corresponding number of image-formed sheets.

FIG. 10 is a schematic diagram illustrating a state where an in-process set value B is set in a factory in the first embodiment.

FIG. 11 is a flowchart of initialization of a toner density sensor of the first embodiment.

FIG. 12 is a flowchart of initialization of a toner density sensor of a second embodiment.

### DESCRIPTION OF THE EMBODIMENTS

### First Embodiment

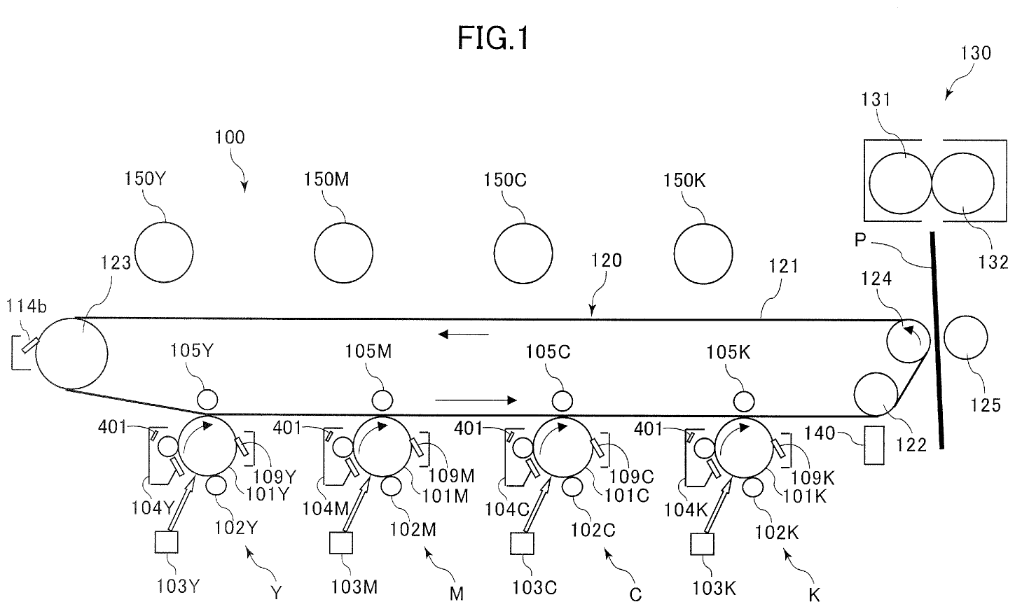

A first embodiment will be described with reference to FIGS. 1 to 11. First, a schematic configuration of an image forming apparatus of the present embodiment will be described with reference to FIGS. 1 to 3.

### Image Forming Apparatus

As illustrated in FIG. 1, an image forming apparatus 100 of the present embodiment includes four image forming stations Y, M, C, and K, disposed in an apparatus body of the image forming apparatus 100. The image forming stations Y, M, C, and K respectively include photosensitive drums 101Y, 101M, 101C, and 101K, as image bearing members. Above the image forming stations, an intermediate transfer apparatus 120 is disposed. In the intermediate transfer apparatus 120, an intermediate transfer belt 121, which is an intermediate transfer member, is stretched and wound around rollers 122, 123, and 124, and is moved (rotated) in a direction indicated by arrows of FIG. 1. The configurations of the image forming stations Y, M, C, and K are the same as each other, except for the color of the toner. Thus, in the following description, only the image forming station Y will be described as one example, and the description for the other image forming stations will be omitted. In the figures, like the image forming station Y, components of each of the other image forming stations are given reference numerals added with an index of M, C, or K, which indicates a corresponding image forming station.

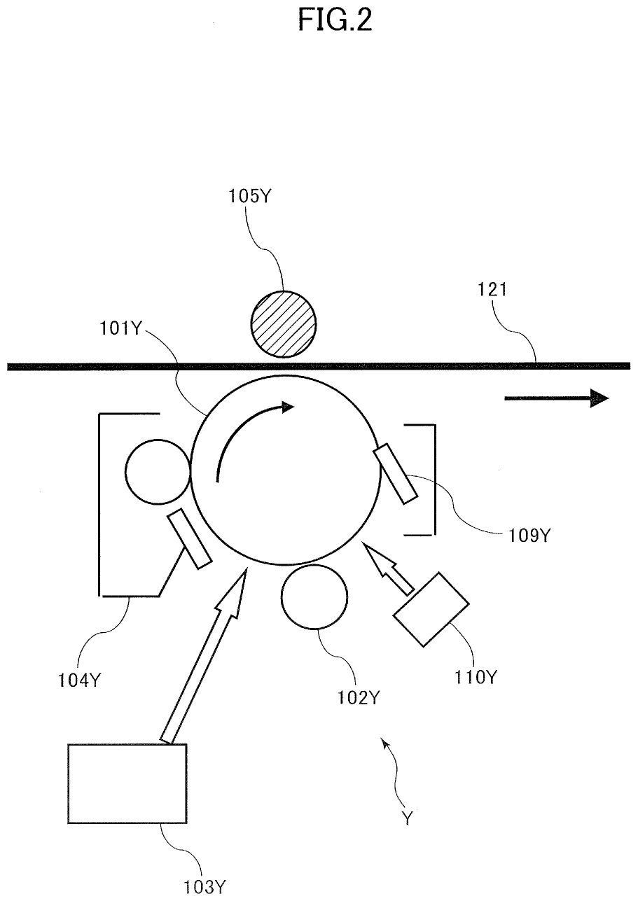

Around the photosensitive drum 101Y, a primary charging apparatus 102Y, a developing apparatus 104Y, and a cleaner 109Y are disposed. With reference to FIGS. 1 and 2, a configuration formed around the photosensitive drum 101Y and an image forming operation will be described. The photosensitive drum 101Y is rotated in a direction indicated by an arrow. The surface of the photosensitive drum 101Y is uniformly charged by the primary charging apparatus 102Y, which is a charging roller that contacts and charges the photosensitive drum 101Y. The charged surface of the photosensitive drum 101Y is exposed by a laser-beam emitting element 103Y, so that an electrostatic latent image is formed on the surface of the photosensitive drum 101Y. The electrostatic latent image formed in this manner is visualized with the toner by the developing apparatus 104Y, and a toner image is formed on the photosensitive drum 101Y. Thus, in the image forming stations Y, M, C, and K, toner images of yellow (Y), magenta (M), cyan (C), and black (K) are formed, respectively.

The toner image formed in the image forming station Y is transferred onto the intermediate transfer belt 121 by a primary transfer bias, applied by the primary transfer roller 105Y The intermediate transfer belt 121 is made of polyimide resin. Similarly, the toner images formed in the other image forming stations are also transferred onto the intermediate transfer belt 121 so as to be superposed on each other. The four-color toner images formed on the intermediate transfer belt 121 is transferred onto a recording material P (e.g. a sheet such as a paper sheet or an OHP sheet) by a secondary transfer roller 125. The secondary transfer roller 125 is a secondary transfer member disposed so as to face the roller 124.

The toner not transferred onto the recording material P and left on the intermediate transfer belt 121 is removed by an intermediate transfer belt cleaner 114b. The recording material P, onto which the toner image has been transferred, is pressurized and heated by a fixing apparatus 130, which includes fixing rollers 131 and 132. With this operation, the toner image is fixed onto the recording material P. The remaining toner left on the photosensitive drum 101Y after the primary transfer is removed by the cleaner 109Y. In addition, the electrical potential produced on the photosensitive drum 101Y is erased by a pre-exposure lamp 110Y illustrated in FIG. 2 for the next image formation.

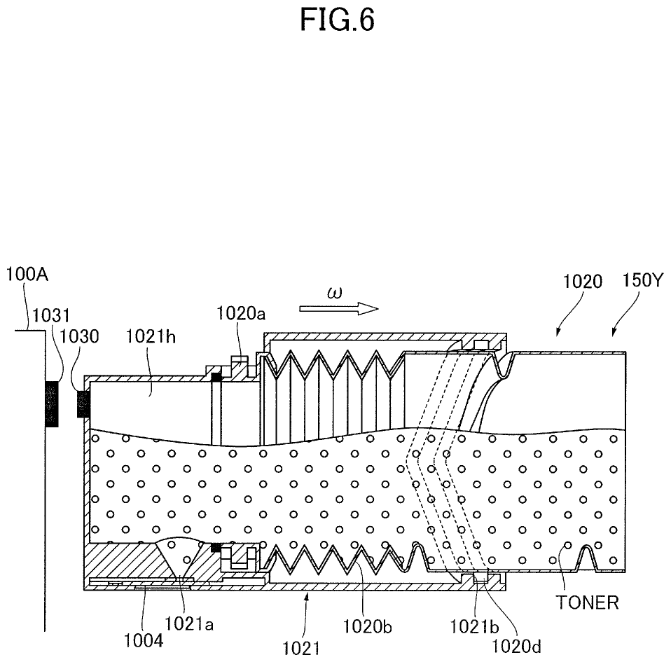

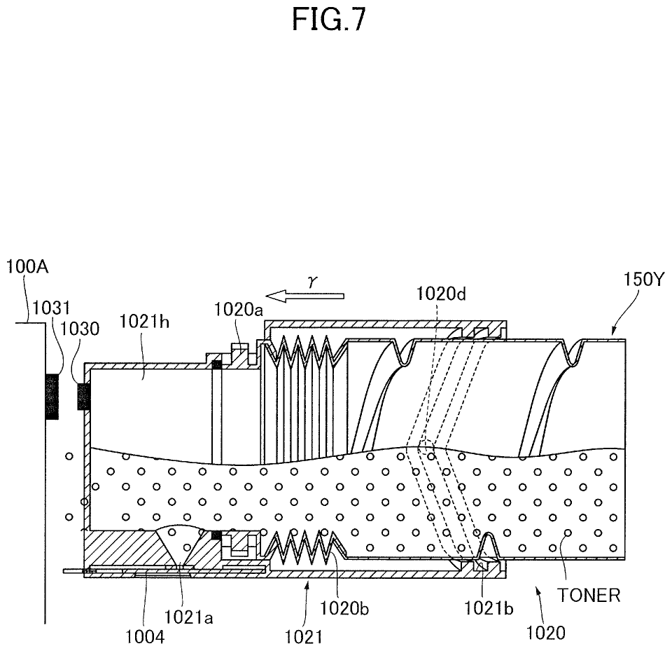

In addition, the image forming apparatus 100 includes toner containers (toner bottles) 150Y, 150M, 150C, and 150K. The toner containers, which are developer accommodating containers, contain replenishment developers, (i.e. toners in the present embodiment) with different colors. The toner containers 150Y, 150M, 150C, and 150K can be detachably attached to the apparatus body 100A (see FIGS. 6 and 7) of the image forming apparatus 100. In a state where the toner containers 150Y, 150M, 150C, and 150K are attached to the apparatus body 100A at predetermined positions of the apparatus body 100A, the toner containers 150Y, 150M, 150C, and 150K can respectively replenish the toners with different colors, to the developing apparatuses 104Y, 104M, 104C, and 104K.

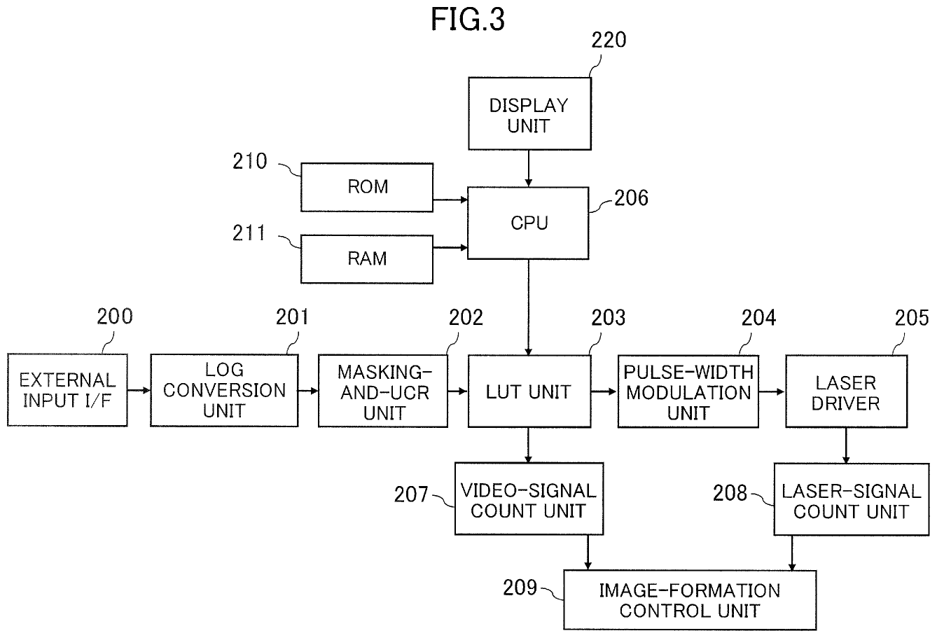

Next, a system configuration of an image processing unit of the image forming apparatus 100 of the present embodiment will be described with reference to FIG. 3. The image processing unit receives RGB color-image data as necessary from an external device (not illustrated), such as a document scanner or a computer (image processing device), via an external input interface (external input I/F) 200.

A LOG conversion unit 201 converts the RGB image data, which is brightness data, to CMY density data (CMY image data), by referring to a look-up table (LUT) constituted by data stored in a ROM 210. A masking-and-UCR unit 202 extracts black (K) component data from the CMY image data, and performs a matrix operation on the CMYK data to correct color impureness of recording color materials.

A look-up table unit (LUT unit) 203 performs density correction on each color of CMYK image data by using a y look-up table, for allowing the image data to have an ideal gradation property of the image forming apparatus. The y look-up table is created by using data stored in a RAM 211, and the contents of the y look-up table are set by a CPU 206.

A pulse-width modulation unit 204 receives image data (image signal) from the LUT unit 203, and outputs a pulse signal whose pulse width corresponds to a level of the image data. A laser driver 205 drives a laser-beam emitting element 103 in accordance with the pulse signal, and causes the laser-beam emitting element 103 to irradiate the surface of the photosensitive drum 101 with the laser beam to form an electrostatic latent image on the surface of the photosensitive drum 101.

A video-signal count unit 207 integrates levels (each level has a value from 0 to 255, for example) of pixels of image data (600 dpi in the present embodiment) received by the LUT unit 203 and forming a single image. The image-data integrated value is referred to as a video count value. The maximum value of the video count value is 529 if all the pixels of an A4-size single image have a level of 255. Here, when the video count value cannot be calculated by the video-signal count unit 207 due to a limited configuration of a circuit of the image forming apparatus 100, it may be calculated by a laser-signal count unit 208, instead of the video-signal count unit 207. In this case, the laser-signal count unit 208 performs the same calculation on an image signal from the laser driver 205, for determining the video count value.

In addition, an image-formation control unit 209 drives and controls components of each of the above-described image forming stations. For example, the image-formation control unit 209 controls the laser driver 205 so that the laser driver 205 drives the laser-beam emitting element 103 in accordance with a pulse signal produced from the image data.

In addition, the image forming apparatus 100 includes a display unit 220, such as an operation panel. The display unit 220 is disposed on a side of the image forming apparatus 100 on which a user operates the image forming apparatus 100, that is, on a front side of the image forming apparatus 100. The display unit 220 displays various conditions of the image forming apparatus 100, and allows a user to perform various types of setting of the image forming apparatus 100. For example, the display unit 220 displays output from the CPU 206, which is an execution unit that will be specifically described later. Here, the various conditions of the image forming apparatus 100 may be displayed by an external terminal, such as a personal computer, connected with the image forming apparatus 100. In this case, the output from the CPU 206 is sent to the personal computer.

### Developing Apparatus

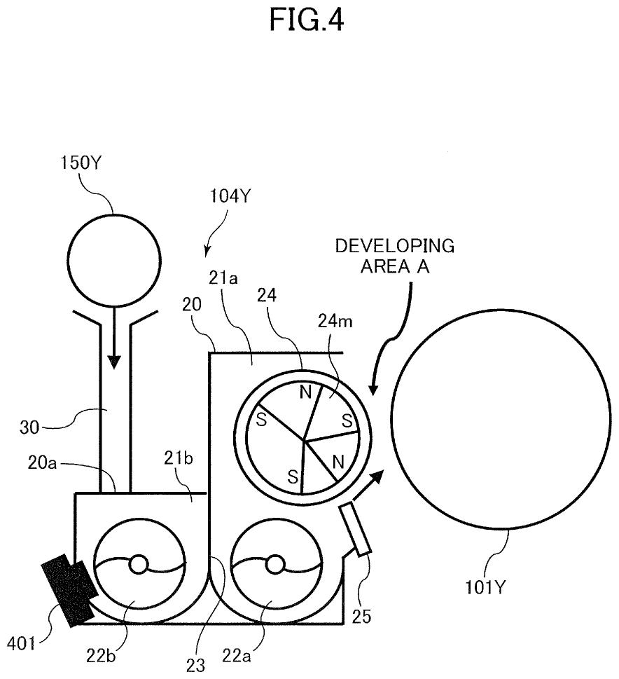

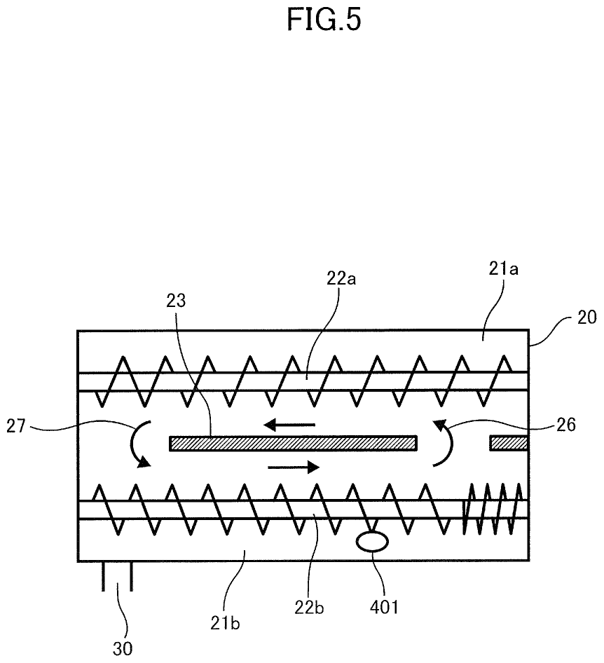

Next, the developing apparatus 104Y of the present embodiment will be described in detail with reference to FIGS. 4 and 5. Here, since the configuration of the other developing apparatuses 104M, 104C, and 104K are the same as that of the developing apparatus 104Y, the description thereof will be omitted. The developing apparatus 104Y includes a developer container 20, which accommodates two-component developer. The two-component developer contains nonmagnetic toner and magnetic carrier. The developing apparatus 104Y develops an electrostatic latent image formed on the photosensitive drum 101Y, by using the developer of the developer container 20. The developing apparatus 104Y also includes a developing sleeve 24 and a brush cutting member 25 serving as regulation blade, both disposed in the developer container 20. The developing sleeve 24 serves as a developer bearing member, and the brush cutting member 25 regulates developer brush serving as magnetic brush born by the developing sleeve 24.

The inside of the developer container 20 is partitioned into a developing chamber 21a and an agitating chamber 21b by a partition wall 23 disposed on a substantially central portion in the developer container 20. The partition wall 23 extends in a direction orthogonal to FIG. 4, and the developing chamber 21a and the agitating chamber 21b are arranged, in FIG. 4, on the right and left sides in a horizontal direction. The developer is accommodated in the developing chamber 21a and the agitating chamber 21b. In addition, a first conveyance screw 22a that is a conveyance member is disposed in the developing chamber 21a, and a second conveyance screw 22b that is a conveyance member is disposed in the agitating chamber 21b. The first conveyance screw 22a and the second conveyance screw 22b can convey the developer in the developer container 20.

As illustrated in FIGS. 4 and 5, the first conveyance screw 22a is disposed in a bottom portion of the developing chamber 21a, substantially parallel to an axis of the developing sleeve 24. When rotated, the first conveyance screw 22a conveys the developer of the developing chamber 21a toward one direction along the axis of the developing sleeve 24. The second conveyance screw 22b is disposed in a bottom portion of the agitating chamber 21b, substantially parallel to the first conveyance screw 22a. The second conveyance screw 22b conveys the developer of the agitating chamber 21b toward a direction opposite to the direction toward which the developer of the developing chamber 21a is conveyed by the first conveyance screw 22a. The first conveyance screw 22a and the second conveyance screw 22b are rotated by an unillustrated motor, which is a driving portion. The motor may also drive the developing sleeve 24.

Thus, since the first conveyance screw 22a and the second conveyance screw 22b are rotated to convey the developer, the developer circulates through the developing chamber 21a and the agitating chamber 21b. As illustrated in FIG. 5, in this circulation, the developer passes through openings (i.e. communicating portions) 26 and 27 formed at both ends of the partition wall 23. In the present embodiment, the developing chamber 21a and the agitating chamber 21b are disposed on the right and left sides in the horizontal direction. The present invention, however, can be applied to a developing apparatus in which the developing chamber 21a and the agitating chamber 21b are vertically arranged, or to other developing apparatuses having different configurations.

The developer container 20 has an inlet 20a through which the developer container 20 receives the developer. The inlet 20a is disposed upstream of the agitating chamber 21b in the direction in which the developer is conveyed by the second conveyance screw 22b. For example, the inlet 20a is disposed upstream with respect to an edge portion of an area of the developing sleeve 24, in which area the developer is born by the developing sleeve 24. As described later, the inlet 20a is connected with an outlet 1021a (FIGS. 6 and 7) via a replenishment pipe 30. Thus, the toner is replenished from the toner container 150Y to the agitating chamber 21b through the inlet 20a. In the agitating chamber 21b, the replenished toner and the developer of the agitating chamber 21b are conveyed while agitated.

The developer container 20 has an opening formed in a developing area A that faces the photosensitive drum 101Y. The developing sleeve 24 is rotatably arranged such that one portion of the developing sleeve 24 is exposed from the opening toward the photosensitive drum 101Y. In the present embodiment, the diameter of the developing sleeve 24 is 18 mm, the diameter of the photosensitive drum 101Y is 30 mm, and the shortest distance between the developing sleeve 24 and the photosensitive drum 101Y is about 300 μm. With this arrangement, the development can be performed in a state where the developer conveyed to the developing area A contacts the photosensitive drum 101Y. The developing sleeve 24 is formed like a cylinder and made of nonmagnetic material such as aluminum or stainless steel. Inside the developing sleeve 24, a magnet roller 24m serving as a magnetic-field generating portion is disposed so as not to rotate.

When the development is performed, the developing sleeve 24 configured as described above is rotated toward a direction indicated by an arrow (counterclockwise), and bears the two-component developer whose layer thickness is regulated by the brush cutting member 25 cutting the magnetic brush. The developing sleeve 24 conveys the developer whose layer thickness is regulated, to the developing area A that faces the photosensitive drum 101Y; and supplies the developer to an electrostatic latent image formed on the photosensitive drum 101Y, to develop the electrostatic latent image. In this time, to increase the efficiency of developing, that is, the percentage of toner used for the electrostatic latent image, the developing sleeve 24 is applied with a development bias voltage from a power source. The development bias voltage is formed such that a direct-current voltage is added with an alternate-current voltage. In the present embodiment, the direct-current voltage has a value of −550 V, and the alternate-current voltage has a peak-to-peak voltage Vpp of 1600 V, and a frequency f of 11 kHz. However, the waveforms of the direct-current voltage and the alternate-current voltage are not limited to the above description.

In the two-component magnetic brush developing, when the alternate-current voltage is applied to the developing sleeve 24, the efficiency of developing commonly increases, increasing the quality of image, whereas the toner fog easily occurs. Thus, for preventing the toner fog, a potential difference is produced between the direct-current voltage applied to the developing sleeve 24 and the charge potential (i.e. white-background potential) of the photosensitive drum 101Y.

The brush cutting member 25 serving as regulation blade is a plate-like nonmagnetic member extending along the longitudinal axis (rotation axis) of the developing sleeve 24 and made of aluminum or the like. In addition, the brush cutting member 25 is disposed upstream from the photosensitive drum 101Y in the rotational direction of the developing sleeve 24. Thus, both the toner and the carrier of the developer are conveyed to the developing area A through a clearance between the leading edge of the brush cutting member 25 and the developing sleeve 24.

The amount of cut of the magnetic brush of developer born by the developing sleeve 24 is regulated by adjusting the clearance between the brush cutting member 25 and the surface of the developing sleeve 24, and thereby the amount of developer conveyed to the developing area A is adjusted. In the present embodiment, the amount of coating of the developer per unit area of the surface of the developing sleeve 24 is regulated to 30 mg/cm², by the brush cutting member 25. The clearance between the brush cutting member 25 and the developing sleeve 24 is in a range from 200 to 1000 and preferably, in a range from 300 to 700 In the present embodiment, the clearance is 400 μm.

In the developing area A, the developing sleeve 24 of the developing apparatus 104Y rotates in the same direction as that of the photosensitive drum 101Y at the position where the developing sleeve 24 faces the photosensitive drum 101Y. The circumferential speed ratio of the speed of the developing sleeve 24 to the speed of the photosensitive drum 101Y is 1.80. The circumferential speed ratio is larger than 0 and equal to or smaller than 3.6, and preferably, equal to or larger than 0.5 and equal to or smaller than 2.0. Here, as the moving speed ratio (the circumferential speed ratio) increases, the efficiency of developing increases. However, if the moving speed ratio is too large, problems such as toner fly and developer deterioration will occur. Thus, the moving speed ratio is preferably in the above-described range.

In addition, as illustrated in FIG. 4, on a lower portion of the outer wall of the agitating chamber 21b (the outer wall is located opposite to the developing chamber 21a), a toner density sensor 401 (which is a permeability sensor in the present embodiment) is fixed such that the detecting surface of the toner density sensor 401 is exposed to the agitating chamber 21b. The toner density sensor 401 serves as a density detecting portion, and detects a permeability of the interior of the developer container. As specifically described later, the toner density sensor 401 detects a toner density (TD ratio) of the developer conveyed by the second conveyance screw 22b, and outputs a voltage corresponding to a detection result. As illustrated in FIG. 5, the toner density sensor 401 is disposed downstream from a center portion of the agitating chamber 21b and upstream from the communicating portion 26 in the conveyance direction of the developer. The communicating portion 26 delivers the developer from the agitating chamber 21b to the developing chamber 21a.

### Developer

Here, the two-component developer of the toner and the carrier contained in the developer container 20 will be described in detail. The toner contains colored resin particles and colored particles. Each of the colored resin particles contains binding resin, coloring agent, and other additives as necessary; each of the colored particles contains external additive such as colloidal-silica fine powder. The toner is polyester resin that can be negatively charged, and the volume average particle diameter of particles of the toner is preferably equal to or larger than 4 μm and equal to or smaller than 10 More preferably, the volume average particle diameter is equal to or smaller than 8 In addition, the toner that is often used in recent years has a low melting point or a low glass transition point Tg (e.g. Tg≤70° C.) to increase its fixing property. Furthermore, the toner may contain wax to increase its separation property required after the fixing. In the present embodiment, the toner of the developer is pulverized toner that contains wax.

The carrier may be made of metal, alloy, or ferrite oxide. The metal may be iron (the surface of which may or may not be oxidized), nickel, cobalt, manganese, chromium, or rare-earth metal; and the alloy may be made by using the above-described examples of the metal. The method of manufacturing these magnetic particles is not limited to a specific method. The weight average particle diameter of particles of the carrier is in a range from 20 to 60 μm, and preferably, in a range from 30 to 50 μm. The resistivity of the carrier is equal to or larger than 10⁷ Ωcm, and preferably, equal to or larger than 10⁸ Ωcm. In the present embodiment, the resistivity is 10⁸ Ωcm.

The volume average particle diameter of particles of the toner of the present embodiment was measured by using the following instrument and method. The measuring instrument used was an instrument for measuring sheath flow electrical resistance particle size distribution, SD-2000, made by SYSMEX CORPORATION. The measurement was performed as follows. First, a dispersant of 0.1 ml and a measurement sample of 0.5 to 50 mg were added to an electrolytic aqueous solution of 100 to 150 ml. The dispersant was a surfactant, but may be alkyl benzene sulfonate. The electrolytic aqueous solution was an NaCl aqueous solution of 1%, prepared by using primary sodium chloride. The electrolytic aqueous solution in which the measurement sample was suspended was dispersed by an ultrasonic disperser for about 1 to 3 minutes. Then, a particle size distribution of particles having diameters of 2 to 40 μm was measured by using the above-described instrument for measuring sheath flow electrical resistance particle size distribution, SD-2000, and by using apertures of 100 μm. A volume average distribution was determined from the particle size distribution, and then the volume average particle diameter was determined from the volume average distribution.

The resistivity of the carrier of the present embodiment was measured by using a sandwich-type cell having a measurement electrode area of 4 cm² and an inter-electrode distance of 0.4 cm. Specifically, one electrode was pressed by a weight of 1 kg, and a voltage E (V/cm) was applied across both electrodes of the cell. In this state, the resistivity of the carrier was determined from the current that flowed in the circuit.

### Toner Container

Next, with reference to FIGS. 6 to 8, the toner containers 150Y to 150K that accommodate the toner will be described. The toner containers 150Y to 150K serve as developer accommodating containers. Here, since the toner containers 150Y to 150K have an identical configuration, the toner container 150Y will be described below as one example.

The toner container 150Y can be detachably attached to the apparatus body 100A at a predetermined position serving as attachment position of the apparatus body 100A. In addition, the toner container 150Y includes an IC tag 1030 disposed at a leading end of the toner container 150Y in the insertion direction and storing information data on the toner container 150Y. On the other hand, the apparatus body 100A includes an attachment sensor 1031. The attachment sensor 1031 serves as an attachment detection portion that determines whether the toner container 150Y is attached to the apparatus body 100A at the predetermined position of the apparatus body 100A. The attachment sensor 1031 is disposed at a position that faces the IC tag 1030 of the toner container 150Y attached to the apparatus body 100A at the predetermined position of the apparatus body 100A, so that the attachment sensor 1031 can communicate with the IC tag 1030 in a contact or noncontact manner. The attachment sensor 1031 receives information data from the IC tag 1030, and thereby detects that the toner container 150Y is attached to the apparatus body 100A at the predetermined position of the apparatus body 100A. Here, the attachment sensor 1031 may not be used. For example, a component such as a fuse may be used to determine whether the toner container 150Y is attached to the apparatus body 100A at the predetermined position of the apparatus body 100A. As another example, another sensor may be used for determining whether the another sensor contacts one portion of the toner container 150Y (for example, a projection of the toner container 150Y that projects toward the another sensor).

As illustrated in FIGS. 6 and 7, the toner container 150Y includes a toner containing portion 1020 formed like a hollow cylinder and having an internal space for containing toner. The toner container 150Y also includes a flange portion 1021 formed on one end side of the toner containing portion 1020 in the longitudinal direction (toner conveyance direction) of the toner containing portion 1020. The toner containing portion 1020 can rotate relative to the flange portion 1021. The flange portion 1021 includes a hollow discharging portion 1021h to temporarily store the toner, which is conveyed from the toner containing portion 1020.

At a bottom portion of the discharging portion 1021h, the outlet 1021a is formed for discharging the toner to the outside of the toner container 150Y, that is, for replenishing the toner to the developing apparatus 104Y. That is, the outlet 1021a can discharge the toner accommodated in the toner container 150Y. Inside the flange portion 1021, a shutter 1004 is disposed. The shutter 1004 serves as a sealing member that can seal the outlet 1021a. The shutter 1004 can open and close the outlet 1021a. Specifically, the shutter 1004 closes the outlet 1021a when the toner container 150Y is not attached to the apparatus body 100A (e.g. when the toner container 150Y is under transportation), and opens the outlet 1021a when the toner container 150Y is attached to the apparatus body 100A at the predetermined position of the apparatus body 100A.

The shutter 1004 functions to prevent the toner from leaking from the toner container 150Y when the toner container 150Y is not attached to the apparatus body 100A. Thus, the shutter 1004 operates in response to an operation of attaching/detaching the toner container 150Y to/from the apparatus body 100A, so that the shutter 1004 opens when the toner container 150Y is attached to the apparatus body 100A at the predetermined position of the apparatus body 100A, and closes when the toner container 150Y is detached from the apparatus body 100A. Specifically, the shutter 1004 moves between a sealing position at which the shutter 1004 seals the outlet 1021a and an opening position at which the shutter 1004 opens the outlet 1021a. Thus, the shutter 1004 is moved by an unillustrated mechanism of the apparatus body 100A, from the sealing position to the opening position along with an attachment operation that the toner container 150Y is attached to the apparatus body 100A at the predetermined position of the apparatus body 100A, and from the opening position to the sealing position along with a separating operation that the toner container 150Y is separated from the predetermined position.

In the present embodiment, as illustrated in FIG. 4, the hopper to temporarily store the developer from the toner container 150Y and replenish the developer to the developer container 20 is not used (hopperless configuration). Thus, when the shutter 1004 opens the outlet 1021a in the state where the toner container 150Y is attached to the apparatus body 100A at the predetermined position of the apparatus body 100A, the outlet 1021a and the inlet 20a of the developer container 20 communicate with each other.

In the present embodiment, the outlet 1021a and the inlet 20a are connected with each other via the replenishment pipe 30. Specifically, the replenishment pipe 30 is disposed in the apparatus body 100A, the toner container 150Y is detachably attached to the upper end of the replenishment pipe 30, and the developing apparatus 104Y is detachably attached to the lower end of the replenishment pipe 30. Thus, when the toner container 150Y is attached to the apparatus body 100A at the predetermined position of the apparatus body 100A, the shutter 1004 opens, and the outlet 1021a is joined with an opening of the replenishment pipe 30 formed at the upper end of the replenishment pipe 30. On the other hand, when the developing apparatus 104Y, which can be detachably attached to the apparatus body 100A, is attached to the apparatus body 100A, the inlet 20a is joined with an opening of the replenishment pipe 30 formed at the lower end of the replenishment pipe 30.

Here, the developing apparatus 104Y may also have a shutter that can open and close the inlet 20a. In this case, it is preferable that the shutter opens in response to an operation of attaching the developing apparatus 104Y to the apparatus body 100A, and closes in response to an operation of detaching the developing apparatus 104Y from the apparatus body 100A.

As illustrated in FIGS. 6 and 7, the toner containing portion 1020 includes a gear portion 1020a, a pump portion 1020b, and a projection portion 1020d. The gear portion 1020a engages with a driving portion of the apparatus body 100A, and transmits rotation-driving force of the apparatus body 100A to the toner containing portion 1020. The pump portion 1020b is a resin volume-variable pump whose volume is changed when the pump portion 1020b reciprocates. In FIGS. 6 and 7, arrows w and y indicate directions in which the pump portion 1020b moves.

Specifically, as illustrated in FIGS. 6 and 7, the pump portion 1020b is a bellows pump in which peak portions and valley portions are alternately and periodically formed on the outer circumferential surface of the pump portion 1020b in the longitudinal direction. Thus, the pump portion 1020b expands and contracts while reciprocating, and functions as an intake-and-discharge mechanism that alternately performs intake operation and discharge operation via the outlet 1021a. In an inner circumferential surface of the flange portion 1021, a cam-shaped groove portion 1021b is formed. The groove portion 1021b engages with the projection portion 1020d of the toner containing portion 1020.

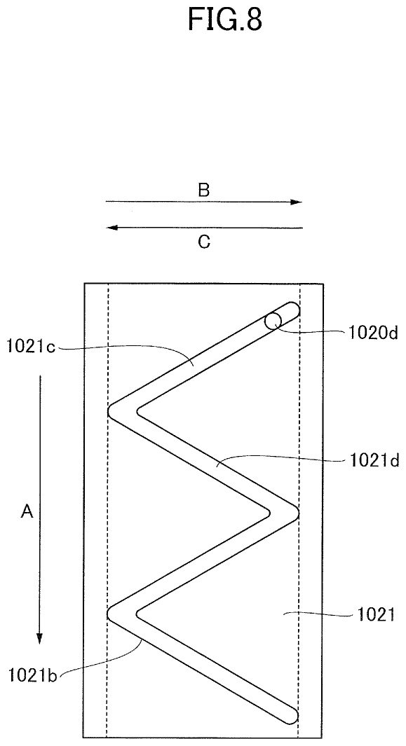

Next, a relationship between the projection portion 1020d and the groove portion 1021b will be described with reference to FIG. 8. FIG. 8 is a schematic diagram illustrating a portion of the flange portion 1021 in which the groove portion 1021b is formed, and which portion is spread in the figure. In FIG. 8, an arrow A indicates a rotational direction of the toner containing portion 1020 (i.e. moving direction of the projection portion 1020d), and arrows B and C indicate directions in which the pump portion 1020b expands and contracts. As illustrated in FIG. 8, the groove portion 1021b includes first grooves 1021c and second grooves 1021d, which are oblique in different directions and alternately joined with each other. When rotated, the toner containing portion 1020 moves relative to the flange portion 1021 in the rotation-axis direction because the projection portion 1020d engages with the groove portion 1021b. As a result, the pump portion 1020b expands and contracts. Since the pump portion 1020b expands and contracts when the toner containing portion 1020 is rotated, the intake-and-discharge mechanism discharges the toner from the outlet 1021a. The toner discharged from the outlet 1021a is supplied to the agitating chamber 21b of the developer container 20, through the replenishment pipe 30 and the inlet 20a (see FIG. 4).

The control for replenishment toner may be performed as follows. That is, the toner is replenished to the developer container 20 though the replenishment pipe 30, by the amount of toner consumed in an image forming operation, by the discharge operation caused by the reciprocating motion of the pump portion 1020b and the gravitational force applied to the toner. The amount of developer to be replenished is determined substantially by the number of reciprocating motions of the pump portion 1020b. The number of reciprocating motions may be determined by the CPU 206 (FIG. 3), depending on a video count value in image data, a detection result by the toner density sensor 401 disposed in the developer container 20, or the like. In the present embodiment, the control for replenishment toner is performed depending on a detection result by the toner density sensor 401 so that a toner density (TD ratio) in the developer container 20 becomes equal to a target toner density, which is determined appropriately in accordance with a state of the image forming apparatus. Here, the toner density (TD ratio) is a ratio of the toner to the carrier (i.e. ratio of the mass of the toner to the sum of the mass of the toner and the mass of the carrier).

### Method of Controlling Target Toner Density

Next, a method of controlling the target toner density of the present embodiment will be described. In the configuration of the present embodiment in which the two-component developer is used, the toner density changes because the toner is consumed in the image forming operation. Since the characteristic of the charged toner of the developer container 20 changes with the change in the toner density, image defects such as unstable image density and toner fog may be produced. Thus, for preventing such image defects, the toner density in the developer container 20 is controlled so as to become equal to the target toner density, by appropriately replenishing the toner.

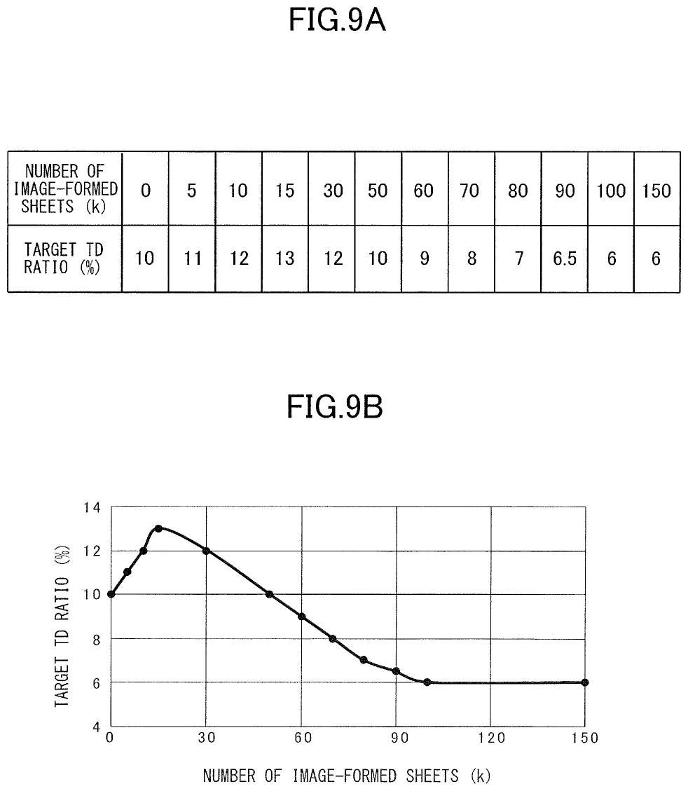

As illustrated in FIGS. 9A and 9B, the present embodiment uses a fixed control table that tabulates the target toner density (target TD ratio) in accordance with the number of image-formed sheets counted from when the use of the developing apparatus 104Y was started. Thus, the control for replenishment toner is performed in accordance with the number of image-formed sheets so that the toner density becomes equal to the target toner density. Here, in the fixed control table of FIG. 9A, values between two adjacent values are linearly interpolated for controlling the target toner density. Thus, the target toner density changes, as illustrated in a graph of FIG. 9B. In addition, a number kin FIGS. 9A and 9B denotes the number of image-formed sheets that is k multiplied by 1,000.

The fixed control table illustrated in FIGS. 9A and 9B is intended as follows. In an early stage in use of the developing apparatus (in the early stage, the number of image-formed sheets is equal to or smaller than about 15 k), the external additives of the toner are easily peeled off from the toner or buried in the toner while the developer is agitated and conveyed in the developing apparatus. As a result, the amount of charge of the toner increases. Thus, to prevent the increase in the amount of charge of the toner, the target TD ratio is increased. With this setting, the toner will less frequently contact the carrier, produce less friction between the toner and the carrier, and be less charged. Consequently, the increase in the amount of charge of the toner will be suppressed. In the present embodiment, in the early stage in use of the developing apparatus, the target TD ratio is set to 10 to 13%. This target TD ratio is same as a value that is set when the developing apparatus or the image forming apparatus is shipped from a factory.

In a late stage in use of the developing apparatus (in the late stage, the number of image-formed sheets is equal to or larger than 60 k), the external additives of the toner and the toner resin adhere to the surface of particles of the carrier in the use of the developing apparatus. As a result, the amount of charge of the toner decreases. Thus, to prevent the decrease in the amount of charge of the toner, the target TD ratio is decreased. With this setting, the toner will more frequently contact the carrier, produce more friction between the toner and the carrier, and be more charged. Consequently, the decrease in the amount of charge of the toner will be suppressed. In the present embodiment, in the late stage in use of the developing apparatus, the target TD ratio is decreased, and is set lower, by 6%, than the factory default value. Here, the service life of the developing apparatus is set as 150 k in the number of image-formed sheets.

In the present embodiment, the target toner density is controlled in the fixed control table, in accordance with the number of image-formed sheets counted from when the use of the developing apparatus was started. However, the scope of the present embodiment is not limited to this. For example, as in the conventional technique, the control table may be changed in accordance with an environment around the developer (such as the temperature or humidity in the apparatus). In another case, the target toner density may be corrected in accordance with an image ratio obtained when the number of image-formed sheets increases. In still another case, a patch image may be formed, as a control toner image, on the photosensitive drum or the intermediate transfer belt in the image forming operation, and the amount of toner on the patch image may be detected for correcting the target toner density. In the present embodiment, a density sensor 140 to detect the density of the patch image (the amount of toner on the patch image) is disposed at a position that faces the intermediate transfer belt 121.

### Toner Density Sensor

Next, the toner density sensor (permeability sensor) 401 will be described. As described above, for stably controlling the toner density, the toner density sensor 401 is required to accurately detect the toner density in the developer container 20. The toner density sensor 401 used is an inductance sensor. The inductance sensor detects an apparent permeability caused by a mixing ratio between the magnetic carrier and the nonmagnetic toner, and converts the permeability into an electrical signal. Then, an actual TD ratio of the developer of the developing apparatus is determined from the detection signal from the inductance sensor. The TD ratio is compared with a reference value, and thereby the toner is replenished as described above.

The toner density sensor 401 includes four bundles of lines (not illustrated): a bundle of lines for applying a power supply voltage (5.0 V in the present embodiment), a bundle of lines for applying a control voltage (4.0 to 6.0 V in the present embodiment), a bundle of lines for earth, and a bundle of lines for outputting an output voltage corresponding to a detection result. These bundles of lines are connected to the CPU 206.

The toner density sensor 401 detects a permeability obtained in the vicinity of the sensor surface of the toner density sensor 401. When the toner density decreases, the ratio of the carrier in the vicinity of the sensor surface relatively increases, increasing the permeability and the output voltage. In contrast, when the toner density increases, the ratio of the carrier in the vicinity of the sensor surface relatively decreases, decreasing the permeability and the output voltage.

Here, the output from the toner density sensor changes in accordance with bulk density of the developer, even though the developer in the vicinity of the sensor surface has a constant toner density. For example, under a high-temperature and high-humidity environment, since the amount of charge of the toner decreases, the Coulomb repulsion between toner particles or carrier particles decreases, and the bulk density of the developer increases. In contrast, under a low-temperature and low-humidity environment, since the amount of charge of the toner increases, the Coulomb repulsion between toner particles or carrier particles increases, and the bulk density of the developer decreases. Thus, even with the developer having a constant toner density, the output voltage has a higher value in the high-temperature and high-humidity environment than a value in the low-temperature and low-humidity environment.

In addition, in a case where a thick paper having a large basis weight is used as recording material, the process speed is reduced from a normal process speed used for plain paper. When the process speed is changed, the rotational speed of the first and the second conveyance screws are also changed. Thus, also in this case, the bulk density of the developer in the vicinity of the sensor surface of the toner density sensor changes. Specifically, when the conveyance speed of the developer reduces, the bulk density increases, increasing the output voltage from the toner density sensor.

Thus, the developing apparatus of the present embodiment controls and changes the control voltage applied to the toner density sensor, in accordance with the operating environment of the developing apparatus (such as temperature, relative humidity, and the absolute amount of moisture) and the process speed (such as constant speed mode or thick paper mode). Thus, the control is performed so that an identical output voltage is outputted for an identical toner density.

### Initialization of Toner Density Sensor

Next, an initialization (initial setting) of the toner density sensor 401 will be described. In recent years, it is required to more accurately detect and control the toner density to satisfy the demand for increasing the image quality and speed of the image forming apparatus. However, the output voltage from the induction-detection toner density sensor varies, even for a constant toner density, due to individual difference in the sensor, dispersion in assembling the sensor to the developer container, and dispersion in the voltage applied to the sensor.

For this reason, the initial setting is performed on the toner density sensor when the image forming apparatus shipped from a factory is initially installed. For example, when the image forming apparatus is installed and the power is turned on for the first time, a plurality of control voltages are applied to the toner density sensor (that is, the control voltage is changed), and output voltages corresponding to the respective control voltages are detected and recorded. Then a control voltage is set so that the output voltage has a desired value. Specifically, since the toner density of the developer of the developing apparatus in the initial installation is the same as the toner density of the developer of the developing apparatus obtained when the developing apparatus is shipped from a factory, the control voltage is set so that the output voltage corresponding to the toner density is outputted. In the present embodiment, the control voltage that is set in this manner is referred to as an on-site set value (first control voltage) A. With this setting, an appropriate control voltage can be set regardless of the above-described dispersion, and the toner density can be accurately detected in the operation performed after the setting.

However, in the hopperless configuration of the present embodiment, when the toner container 150Y is attached to the apparatus body 100A at the predetermined position of the apparatus body 100A before the initialization of the toner density sensor, the developer in the toner container 150Y may have entered the developing apparatus 104Y. For example, there is a case in which the toner container 150Y is packed together with the apparatus body 100A of the image forming apparatus when they are shipped from a factory. In this case, a spacer may be interposed between the toner container 150Y and one portion of the apparatus body 100A to attach the toner container 150Y to the apparatus body 100A at a position other than the predetermined position. Even in this case, however, if the spacer is removed and the toner container 150Y is attached to the apparatus body 100A at the predetermined position of the apparatus body 100A before the initialization of the toner density sensor, the same problem may occur.

In addition, even in a case where the toner container 150Y is not attached to the apparatus body 100A when the apparatus body 100A is shipped from a factory, if the toner container 150Y separately shipped from the factory is attached to the apparatus body 100A at the predetermined position of the apparatus body 100A in an installation site before the initialization of the toner density sensor, the same problem may occur. In the present embodiment, when the toner container 150Y is attached to the apparatus body 100A at the predetermined position of the apparatus body 100A, the outlet 1021a of the toner container 150Y and the inlet 20a of the developer container 20 communicate with each other. Thus, as described above, if the toner in the toner container 150Y enters the developing apparatus 104Y before the initialization of the toner density sensor, the toner density in the developer container may change, before the initialization, from a factory default value.

Hereinafter, the detailed description thereof will be made. In the image forming apparatus 100 of the present embodiment, when the toner container 150Y is attached to the apparatus body 100A at the predetermined position of the apparatus body 100A, the shutter 1004 is mechanically and automatically opened, and the outlet 1021a communicates with the inlet 20a of the developer container 20 via the replenishment pipe 30. At this time, if the replenishment toner in the toner container 150Y has high fluidity, the toner may fall into the agitating chamber 21b of the developer container 20, due to the vibration caused by the attachment of the toner container 150Y. As a result, the fallen toner changes the TD ratio of the developer in the developer container 20, from a factory default value.

In such a configuration, if the toner density sensor 401 of the developing apparatus 104Y is initialized in the initial installation after the toner container 150Y is attached to the apparatus body 100A, the accurate initialization cannot be performed because the TD ratio has changed. As countermeasures to this problem, an installation manual might be provided for instructing a user to attach the toner container 150Y to the apparatus body 100A after the initialization. However, if an actual installation worker makes a mistake on the installation procedure, the above-described problem will occur.

Thus, in the present embodiment, the initialization is performed in accordance with the following sequence. As a result, even when an installation worker makes a mistake on the installation procedure and attaches the toner container 150Y to the apparatus body 100A at the predetermined position of the apparatus body 100A before the initialization, the initialization can be performed accurately.

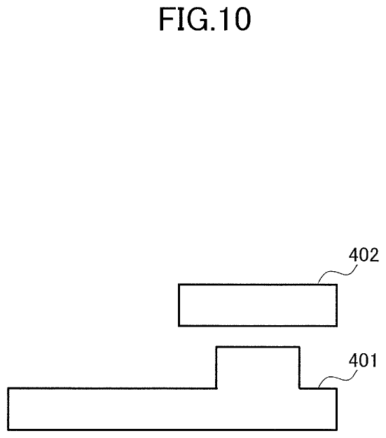

In the present embodiment, a control voltage to be applied to the toner density sensor 401 is preset in a factory in which the developing apparatus 104Y is assembled. Specifically, as illustrated in FIG. 10, a reference magnetic material 402 is placed at a position that faces a detection surface of the toner density sensor 401, and a plurality of control voltages are applied to the toner density sensor 401 (that is, the control voltage is changed). In this time, output voltages corresponding to the respective control voltages are detected. Then a control voltage is set so that the output voltage has a desired value corresponding to the permeability of the magnetic material 402. In the present embodiment, the control voltage that is preset in a factory in this manner is referred to as an in-process set value (second control voltage) B.

The in-process set value B may be stored in the IC tag of the developing apparatus 104Y, and read by the CPU 206 (FIG. 3) communicating with the IC tag, when the developing apparatus 104Y is attached to the apparatus body 100A. Alternatively, the in-process set value B may be stored in a memory of the apparatus body 100A of the image forming apparatus 100. The same holds true for the other developing apparatuses 104M to 104K.

As described above, the in-process set value B is preset in a factory. Thus, because of the environment in the factory or tolerance of a jig used in the setting, the accuracy of the in-process set value B is lower than the accuracy of the on-site set value A that is set in the initialization performed after the image forming apparatus is installed in a customer's site or the like. As described above, however, if the developer enters the developing apparatus 104Y before the initialization, any appropriate setting value will not be obtained even though the initialization is performed. As countermeasures to this problem, the present embodiment allows the in-process set value B, which is preset in a factory, to be set as a control voltage used in the image forming operation. The in-process set value B is not as accurate as the on-site set value A, which is set in the initialization, but has accuracy enough to ensure the performance of a corresponding product.

### Sequence of Initialization

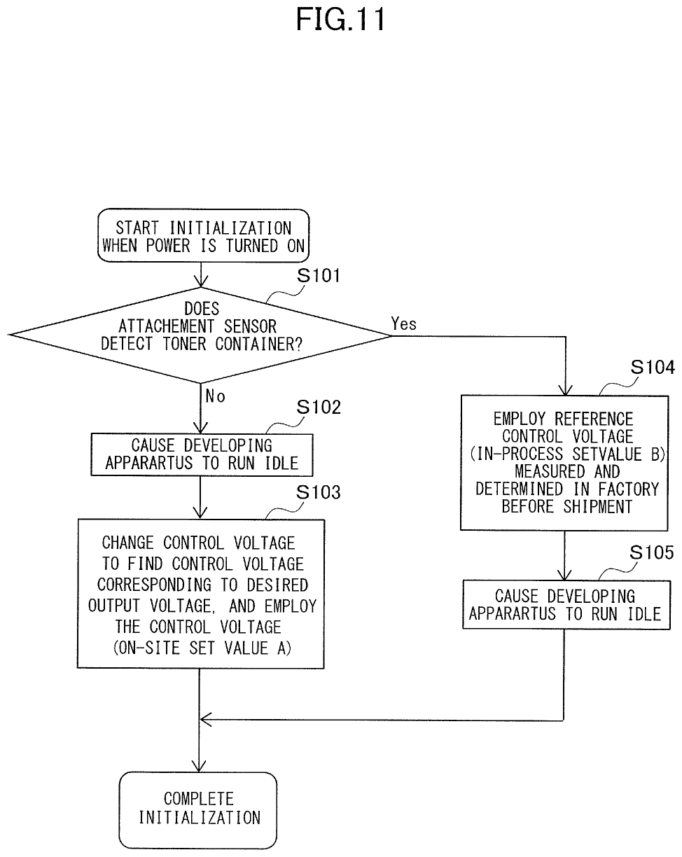

Next, a sequence of the initialization of the present embodiment, performed in the initial installation of the image forming apparatus 100, will be described with reference to FIG. 11. Here, although the description will be made for the toner container 150Y, the descriptions for the other toner containers 150M to 150K are the same as that for the toner container 150Y.

First, when the power of the image forming apparatus 100 shipped from a factory is turned on in the initial installation, the CPU 206 causes the attachment sensor 1031 to determine whether the toner container 150Y is attached to the apparatus body 100A at the predetermined position of the apparatus body 100A (S101). That is, if the attachment sensor 1031 detects the IC tag 1030 (FIGS. 6 and 7) of the toner container 150Y, then the CPU 206 determines that the toner container 150Y is attached to the apparatus body 100A at the predetermined position of the apparatus body 100A. In contrast, if the attachment sensor 1031 does not detect the IC tag 1030, then the CPU 206 determines that the toner container 150Y is not attached to the apparatus body 100A at the predetermined position of the apparatus body 100A.

If the toner container 150Y is not attached to the apparatus body 100A at the predetermined position of the apparatus body 100A (S101: No), the toner has not entered the developer container 20. Thus, the factory default toner density of the developer (i.e. 10% in the TD ratio in the present embodiment) is ensured. Consequently, the CPU 206 causes the developing apparatus 104Y to run idle (S102). In this idling operation, the CPU 206 causes the first conveyance screw 22a and the second conveyance screw 22b to rotate in a predetermined time in a state where no electrostatic latent image is formed on the photosensitive drum 101Y. Through this idling operation, the amount of charge of the toner can be stabilized by agitating the developer of the developer container 20, and the accuracy of the initialization performed after the idling operation can be increased.

Here, in this idling operation, the in-process set value B, which is a predetermined control voltage that is preset in a factory, is applied to the toner density sensor 401. That is, in the idling operation, the first conveyance screw 22a and the second conveyance screw 22b are driven while the in-process set value B, which is a control voltage, is applied to the toner density sensor 401. In this manner, the control voltage is applied in the idling operation for monitoring the output signal from the toner density sensor 401. Specifically, since the output signal from the toner density sensor 401 changes periodically in accordance with the rotation of the second conveyance screw 22b, the output signal from the toner density sensor 401 is monitored for checking that the first and the second conveyance screws 22a and 22b are not rotated in the idling operation, and that the rotational speed of the first and the second conveyance screws 22a and 22b is unusual.

After causing the first and the second conveyance screws 22a and 22b to run idle, the CPU 206 executes a mode to apply a plurality of control voltages to the toner density sensor 401 (that is, change the control voltage), detects the respective output voltages corresponding to the control voltages, finds a control voltage corresponding to a desired output voltage, and employs the control voltage (on-site set value A) (first mode, S103). The CPU 206 then uses the control voltage for controlling the toner density sensor 401. After Step S103 in which the control voltage is determined, the CPU 206 completes the initialization, and performs an image forming operation.

Here, after completing the initialization, the CPU 206 outputs a signal indicating the completion of the initialization, to the display unit 220 (FIG. 3). The display unit 220 can display a message indicating the completion of the initialization, to inform an operator, such as a service man, of the completion of the initialization. Alternatively, the CPU 206 may output a signal indicating the completion of the initialization, to an external terminal, such as a personal computer, connected to the image forming apparatus 100.

In the present embodiment, the on-site set value A is set as follows. First, the CPU 206 measures the output voltage every time the CPU 206 changes the control voltage applied to the toner density sensor 401, by 0.1 V at a time. Then the CPU 206 performs the linear interpolation, and calculates a control voltage (on-site set value A) corresponding to a desired output voltage.

On the other hand, if the toner container 150Y is attached to the apparatus body 100A at the predetermined position of the apparatus body 100A (S101: Yes), the toner may have entered the developer container 20 due to vibration or impact caused by the attachment of the toner container 150Y. Thus, the factory default toner density of the developer of the developer container 20 is not guaranteed in this state. In this case, the CPU 206 does not perform the above-described mode, and employs a preset reference control voltage (in-process set value B), as a control voltage used for controlling the toner density sensor 401 (second mode, S104). Then the CPU 206 causes the developing apparatus 104Y to run idle (S105), as in Step S102, for stabilizing the amount of charge of the toner. After that, the CPU 206 completes the initialization, and performs an image forming operation. Also in this case, the CPU 206 outputs a signal indicating the completion of the initialization, to the display unit 220 (FIG. 3).

In the present embodiment, the preset reference control voltage (in-process set value B) is stored in a memory of the apparatus body 100A. The in-process set value B may be stored in an IC tag. In this case, the IC tag may be disposed in the developing apparatus 104Y, and may be read by the CPU 206 communicating with the IC tag, when the developing apparatus 104Y is attached to the apparatus body 100A. In addition, if the toner container 150Y is attached to the apparatus body 100A (S101: Yes), the CPU 206 may skip Step S105 and complete the initialization. In this case, the CPU 206 causes the developer container 20 to run idle before the first image forming operation.

Thus, in the present embodiment, even when the toner container 150Y is attached to the apparatus body 100A at the predetermined position of the apparatus body 100A before the initial setting, the accuracy of the initial setting of the toner density sensor 401 can be ensured. As described above, when the toner container 150Y is attached to the apparatus body 100A at the predetermined position of the apparatus body 100A before the initialization, the outlet 1021a of the toner container 150Y and the inlet 20a of the developer container 20 communicate with each other, and the toner may enter the developer container 20 before the initialization. In the present embodiment, however, even when the toner enters the developer container 20 before the initialization of the toner density sensor 401, the in-process set value B, which is preset in a factory and ensures a certain level of accuracy, is set as a control voltage applied in the image forming operation. As a result, the toner density sensor 401 can detect the toner density with high accuracy.

### Second Embodiment

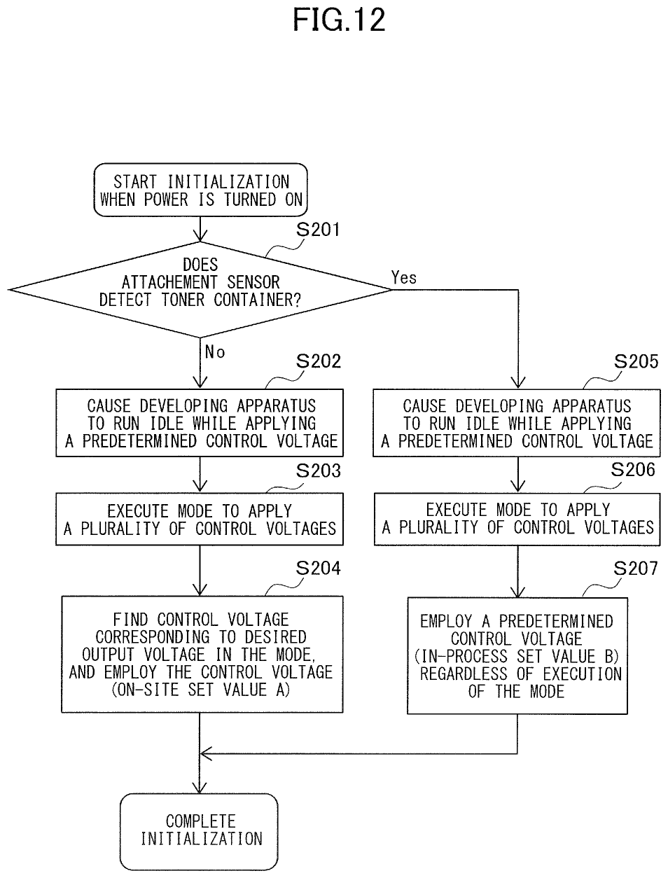

A second embodiment will be described with reference to FIG. 12. In the sequence of the initialization of the above-described first embodiment, the mode to apply a plurality of control voltages to the toner density sensor 401 (that is, change the control voltage) is not performed when the toner container has been attached to the apparatus body at the predetermine position of the apparatus body in the initial installation. In the present embodiment, the mode to apply a plurality of control voltages to the toner density sensor 401 is performed even when the toner container has been attached to the apparatus body 100A. Since the other configuration and operation are the same as those of the first embodiment, duplicated description and illustration will be omitted or simplified, and different features from the first embodiment will be mainly described below.

A sequence of the initialization of the present embodiment, performed in the initial installation of the image forming apparatus 100, will be described with reference to FIG. 12. Here, although the description will be made for the toner container 150Y, the descriptions for the other toner containers 150M to 150K are the same as that for the toner container 150Y.

As in the first embodiment, when the power of the image forming apparatus 100 is turned on in the initial installation, the CPU 206 causes the attachment sensor 1031 to determine whether the toner container 150Y is attached to the apparatus body 100A at the predetermined position of the apparatus body 100A (S201). If the toner container 150Y is not attached to the apparatus body 100A at the predetermined position of the apparatus body 100A (Step 201: No), the CPU 206 causes the developing apparatus 104Y to run idle for a predetermined time while applying the control voltage having the in-process set value B to the toner density sensor 401, as in the first embodiment (S202). Then, as in the first embodiment, the CPU 206 executes the mode to apply a plurality of control voltages to the toner density sensor 401 (that is, change the control voltage) (S203). Then the CPU 206 detects the respective output voltages corresponding to the control voltages, finds a control voltage corresponding to a desired output voltage, and employs the control voltage (on-site set value A) (S204). With this operation, the CPU 206 completes the initialization.

If the toner container 150Y is attached to the apparatus body 100A at the predetermined position of the apparatus body 100A (Step 201: Yes), the CPU 206 causes the developing apparatus 104Y to run idle for a predetermined time while applying the control voltage having the in-process set value B to the toner density sensor 401, as in the first embodiment (S205). Then, as in Step S203, the CPU 206 executes the mode to apply a plurality of control voltages to the toner density sensor 401 (that is, change the control voltage) (S206). In this case, regardless of the relationship between the plurality of control voltages and the plurality of output voltages outputted in the above-described mode, the CPU 206 employs a preset reference control voltage (in-process set value B), as a control voltage used for controlling the toner density sensor 401 (S207). With this operation, the CPU 206 completes the initialization.

Here, the Step S207 may be performed at another timing, such as before Step S205 or between Step S205 and Step S206. In addition, if the toner container 150Y is attached to the apparatus body 100A (S201: Yes), the CPU 206 may skip Step S205, execute the steps S206 and S207, and complete the initialization. In this case, the CPU 206 causes the developer container 20 to run idle before the first image forming operation.

Thus, also in the present embodiment, even when the toner container 150Y has been attached to the apparatus body 100A at the predetermined position of the apparatus body 100A in the initial setting of the toner density sensor 401, the accuracy of the initial setting of the toner density sensor 401 can be ensured, as in the first embodiment. As a result, the toner density sensor 401 can detect the toner density with high accuracy.

### OTHER EMBODIMENTS

In the above description, the sealing member is a shutter. However, the sealing member may be a sheet to seal the outlet 1021a. Specifically, the sheet seals the outlet 1021a when stuck on the toner container 150Y via adhesive so as to cover the outlet 1021a. The outlet 1021a may be opened by peeling off the sheet, after or immediately before the toner container 150Y is attached to the apparatus body 100A at the predetermined position of the apparatus body 100A. Alternatively, the sheet may be automatically reeled when the toner container 150Y is attached to the apparatus body 100A at the predetermined position of the apparatus body 100A.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-212579, filed Nov. 12, 2018 which is hereby incorporated by reference herein in its entirety.

What is claimed is:

1. An image forming apparatus comprising:
an image bearing member;
a developing apparatus comprising a developer container in which developer, containing toner and carrier, is accommodated and configured to develop an electrostatic latent image formed on the image bearing member by using the developer in the developer container, the developer container comprising an inlet through which the developer container receives the developer;
a developer accommodating container in which developer is accommodated, and which comprises an outlet through which the developer in the developer accommodating container is discharged, the developer accommodating container being configured to attach to the image forming apparatus at an attachment position, the outlet of the developer accommodating container communicating with the inlet of the developer container in a state where the developer accommodating container is attached to the image forming apparatus at the attachment position so that the developer in the developer accommodating container flows from the outlet to the developer container;
a density detecting portion configured to output an output voltage corresponding to a toner density in the developer container if a control voltage is applied to the density detecting portion; and
an execution unit configured to execute a first mode if an initial setting of the density detecting portion is performed in a state where the developer accommodating container is not attached to the image forming apparatus at the attachment position in an initial installation of the image forming apparatus, and to execute a second mode if the initial setting of the density detecting portion is performed in the state where the developer accommodating container is attached to the image forming apparatus at the attachment position in the initial installation of the image forming apparatus,
wherein, in the first mode, the execution unit applies a plurality of control voltages to the density detecting portion, determines a first control voltage based on the plurality of control voltages and a plurality of output voltages outputted from the density detecting portion when the plurality of control voltages are applied to the density detecting portion, and sets the first control voltage as the control voltage to be applied to the density detecting portion when an image is formed, and
wherein, in the second mode, the execution unit sets a preset second control voltage as the control voltage to be applied to the density detecting portion when an image is formed.

2. The image forming apparatus according to claim 1, wherein, in the second mode, the execution unit applies a plurality of control voltages to the density detecting portion, and sets the second control voltage as the control voltage to be applied to the density detecting portion when an image is formed, regardless of the plurality of control voltages and a plurality of output voltages outputted from the density detecting portion when the plurality of control voltages are applied to the density detecting portion.

3. The image forming apparatus according to claim 1, wherein the developing apparatus comprises a conveyance member configured to convey the developer in the developer container, and
wherein, if the initial setting of the density detecting portion is performed in the state where the developer accommodating container is not attached to the image forming apparatus at the attachment position in the initial installation of the image forming apparatus, the execution unit drives the conveyance member for a predetermined time while no electrostatic latent image is formed on the image bearing member and then, executes the first mode.

4. The image forming apparatus according to claim 1, wherein the developing apparatus comprises a conveyance member configured to convey the developer in the developer container, and
wherein, if the initial setting of the density detecting portion is performed in the state where the developer accommodating container is attached to the image forming apparatus at the attachment position in the initial installation of the image forming apparatus, the execution unit drives the conveyance member for a predetermined time while no electrostatic latent image is formed on the image bearing member, and then executes the second mode.

5. The image forming apparatus according to claim 1, further comprising an attachment detection portion configured to detect that the developer accommodating container is attached to the image forming apparatus at the attachment position of the image forming apparatus,
wherein the execution unit executes the first mode, if the initial setting of the density detecting portion is performed in a state where the attachment detection portion has not detected that the developer accommodating container is attached to the image forming apparatus at the attachment position in the initial installation of the image forming apparatus, and
wherein the execution unit executes the second mode, if the initial setting of the density detecting portion is performed in a state where the attachment detection portion has detected that the developer accommodating container is attached to the image forming apparatus at the attachment position in the initial installation of the image forming apparatus.

6. The image forming apparatus according to claim 1, wherein the developer accommodating container comprises a sealing member configured to seal the outlet, and
wherein the sealing member seals the outlet in a state where the developer accommodating container is not attached to the image forming apparatus at the attachment position, and opens the outlet in a state where the developer accommodating container is attached to the image forming apparatus at the attachment position.

7. The image forming apparatus according to claim 6, wherein the sealing member is a shutter configured to move between a sealing position at which the shutter seals the outlet and an opening position at which the shutter opens the outlet,
wherein the shutter moves from the sealing position to the opening position along with an attachment operation that the developer accommodating container is attached to the image forming apparatus at the attachment position, and
wherein the shutter moves from the opening position to the sealing position along with a separating operation that the developer accommodating container is separated from the attachment position.

8. The image forming apparatus according to claim 1, wherein the density detecting portion is an inductance sensor.
